(19) United States
(12) Patent Application Publication
(10) Pub. No.: US 2005/0255750 A1
(43) Pub. Date: Nov. 17, 2005

(54) Connector

(76) Inventor: Johnson Yang, Jhonghe City (TW)

Correspondence Address: CHARLES E. BAXLEY, ESQ., 90 JOHN STREET, THIRD FLOOR, NEW YORK, NY, 10038, US

(21) Appl. No.: 11/183,622

(22) Filed: Jul. 18, 2005

(30) Foreign Application Priority Data
Feb. 4, 2004 (TW) 094202203

(51) Int. Cl. H01R 13/40

(52) U.S. Cl. 439/595

(57) ABSTRACT

The present invention relates to a connector, and more particularly to a connector with a high definition multimedia interface. The connector comprises a plurality of terminals are inserted in a receiving groove of a base thereof, a locking block is positioned in the receiving groove of the base of the connector, and on the locking block are formed a plurality of inserting holes for insertion of terminals, thus preventing the terminals from deformation and getting loose caused by external force, and minimizing the occurrence of bad contact and facilitating assembly.

### BACKGROUND OF THE INVENTION

1. Field of the Invention

The present invention relates to a connector, and more particularly to a connector with a high definition multimedia interface.

2. Description of the Prior Art

Referring to FIGS. 1-3, a conventional connector generally comprises a housing 10 having a plurality of inserting grooves 11 received with terminals 12, a base 20 is disposed in the recess 13 of the housing 10 in such a manner that a pair of positioning members 14 in the recess 13 of the housing 10 are to be inserted in the lateral groove 21 at either side of the base 20, and locking portion 15 of the housing 10 abut against the rear edge of the base 20. An inserting side of the base 20 to be inserted in the housing 10 is provided with a forked elastic piece 22 that serves to abut against the upper surface of the recess 13. On another side of the base 20, opposite the inserting side, is formed at a slot 23 in which are formed a plurality of inserting holes 24 for insertion of terminals 26. The inserting holes 24 are separated from one another by a plurality of spacers 25, and the spaces between the spacers 25 are provided for positioning the terminals 26. This conventional connector has been used for a long time, however, it still has some defects as follows:

First, the respective components of the connector are very small, therefore, making the plurality of spacers 25 in such a tiny slot 23 and inserting the terminals 26 into spaces between the spacers 25 are difficult.

Second, in assembly, the terminals 26 are susceptible to deformation since they are only confined and positioned in the spacers 25 of the base 20.

The present invention has arisen to mitigate and/or obviate the afore-described disadvantages.

### SUMMARY OF THE INVENTION

The primary objective of the present invention is to provide a connector with a high definition multimedia interface, after the terminals are inserted in the base of the connector, a locking block is pressed in the base for insertion of the terminals. Therefore, the locking block improves the terminals in relation to the base, and prevents the occurrence of deformation and poor contact of the terminals.

A connector in accordance with the present invention comprises a plurality of terminals inserted in a receiving groove of a base thereof, and a locking block is positioned in the receiving groove of the base of the connector, and on the locking block are formed a plurality of inserting holes for insertion of terminals.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of conventional connector;

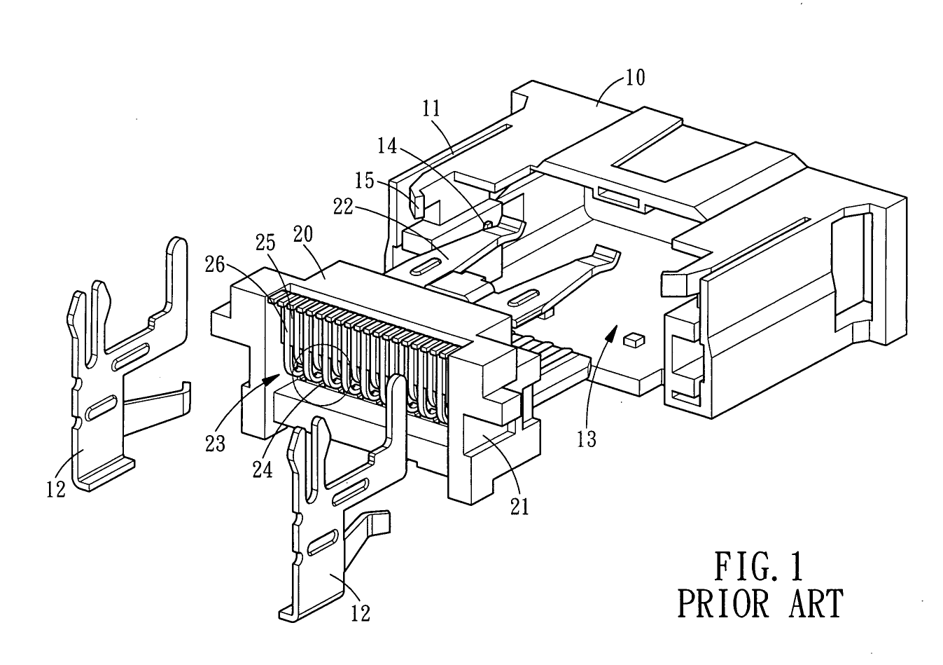

FIG. 2 is an assembly view of the conventional connector;

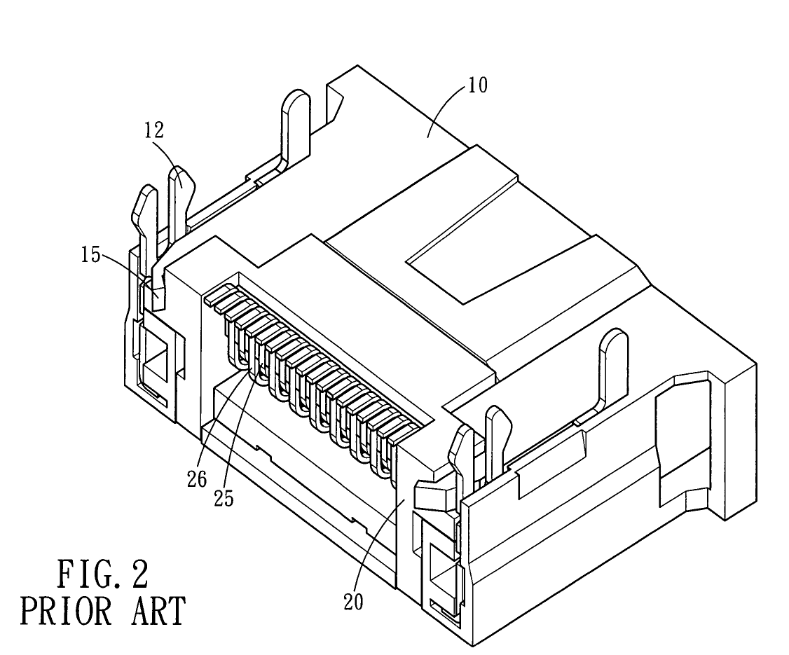

FIG. 3 is an enlarged view of a part of the conventional connector;

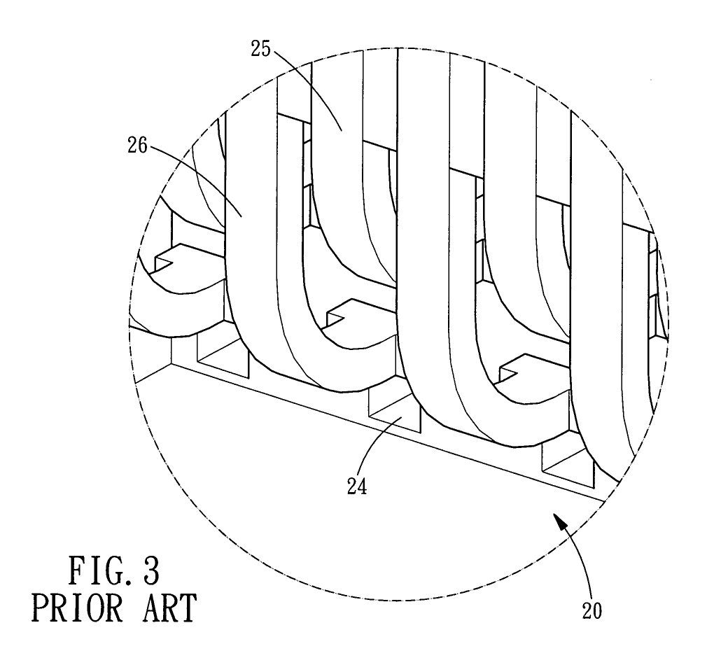

FIG. 4 is an exploded view of a connector in accordance with a first embodiment of the present invention;

FIG. 5 is an assembly view of the connector in accordance with a first embodiment of the present invention;

FIG. 6 is an assembly cross sectional view of the connector in accordance with a first embodiment of the present invention;

FIG. 7 is an exploded view of a connector in accordance with a second embodiment of the present invention.

### DETAILED DESCRIPTION OF THE PREFERRED EMBODIMENTS

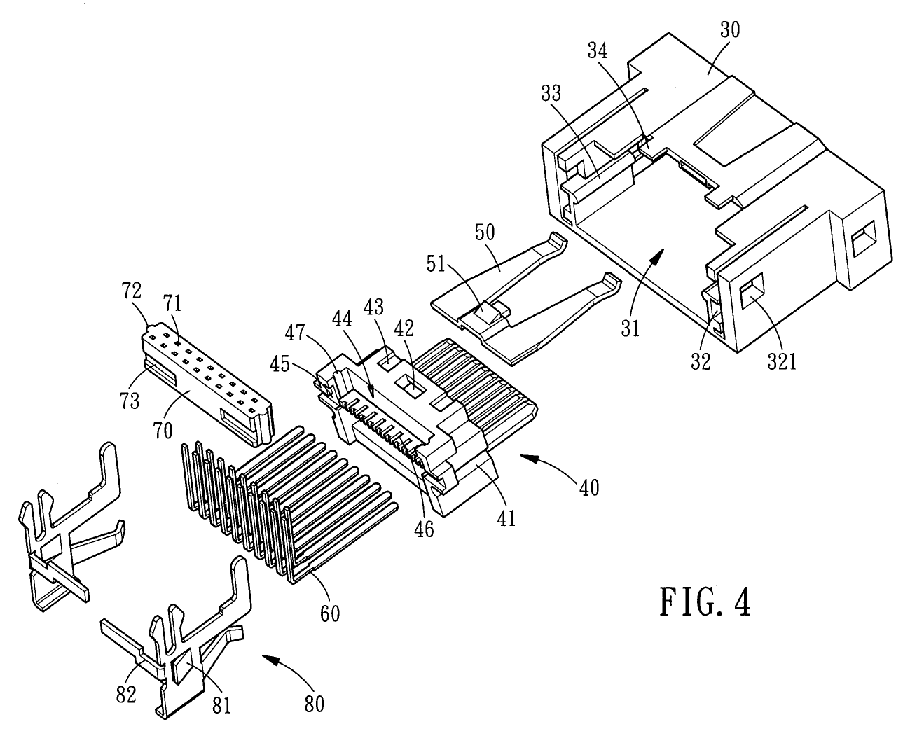

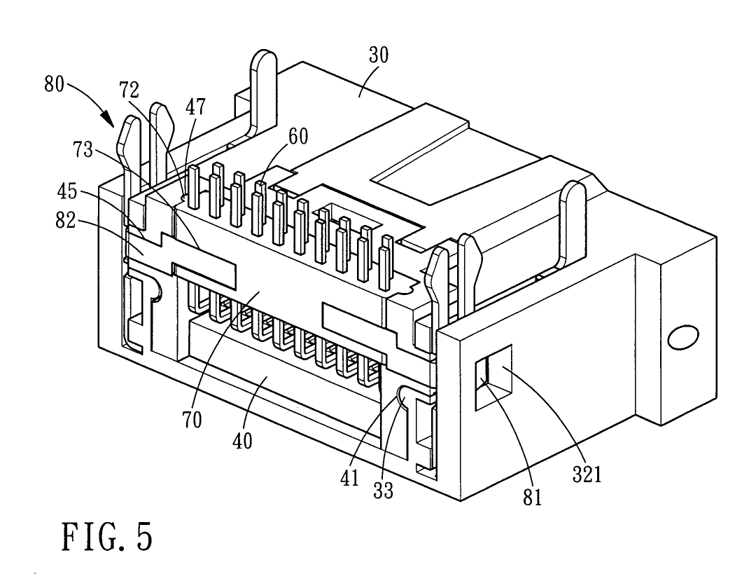

Referring to FIGS. 4 and 5, a connector in accordance with a first embodiment of the present invention is shown and comprises a housing 30, a base 40, an elastic piece 50, a plurality of terminals 60, a locking block 70 and two independent pins 80.

The housing 30 is a unitary structure and is formed at a front side thereof with a recess 31, at either side of the recess 31 is formed an inserting groove 32. At either lateral side of the housing 30 is formed a locking hole 321 in communication with the inserting groove 32, and a pair of semicircular rails 33 are oppositely arranged in the recess 31. On the housing 30 and at the upper edge of the recess 31 is formed a pair of positioning protrusions 34.

The base 40 is a unitary structure having a pair of guiding grooves 41 for mating with the rails 33 of the housing 30. A front side of the base 40 for inserting in the housing 30 is formed with a pair of cavities 43 for mating with the pair of positioning protrusions 34, and a locking hole 42. On a rear side of the base 40 is formed a receiving groove 44, and at either side of the receiving groove 44 is a positioning groove 45. In the receiving groove 44 are formed a plurality of inserting holes 46 and two opposite locking grooves 47.

The elastic piece 50 is fork-shaped and formed with a locking portion 51 to be locked in the locking hole 42 of the base 40, and the elastic piece 50 is inserted in the recess 31 of the housing 30.

Each of the plurality of terminals 60 is a L-shaped metal member having a long end inserted in the inserting hole 46 of the base 40.

The locking block 70 is inserted in the receiving groove 44 of the base 40 and has a plurality of inserting holes 71 for insertion of the plurality of terminals 60. At either side of the locking block 70 is formed a rib 72 having a semicircular cross section for mating with the locking grooves 47 of the base 40. At a lateral surface of the locking block 70 are formed two notches 73.

The two independent pins 80 are inserted in the inserting groove 32 of the housing 30 and each has a retaining structure 81 to be locked in the locking hole 321 of the housing 30 and has a positioning portion 82 to be positioned in the positioning groove 45 of the base 40 and the notches 73 of the locking block 70.

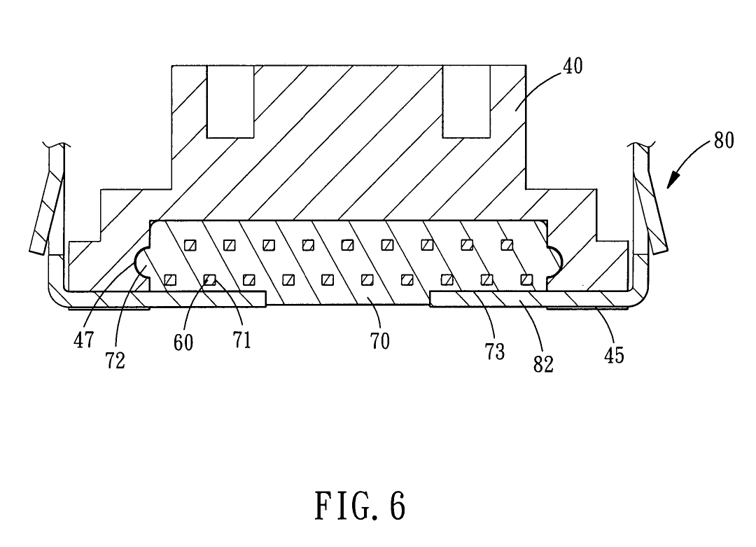

For a better understanding of the present invention, its operations and functions, references should be made to FIGS. 5 and 6, the locking block 70 is positioned in the receiving groove 44 of the base 40 in such a manner that the terminals 60 are inserted in the inserting holes 71 of the locking block 70, and the ribs 72 of the locking block 70 are inserted in the two opposite locking grooves 47 of the base 40.

In addition, after the independent pins 80 are inserted in the inserting grooves 32 of the housing 30, the positioning portion 82 will right be locked in the positioning groove 45 of the base 40 and the notches 73 of the locking block 70, thus positioning the locking block 70.

With the structural design of the locking block 70 and the base 40, the terminals 60 are positioned by the locking block 70 and the base 40, thus preventing the terminals 60 from deformation and getting loose caused by external force, and minimizing the occurrence of bad contact and facilitating assembly.

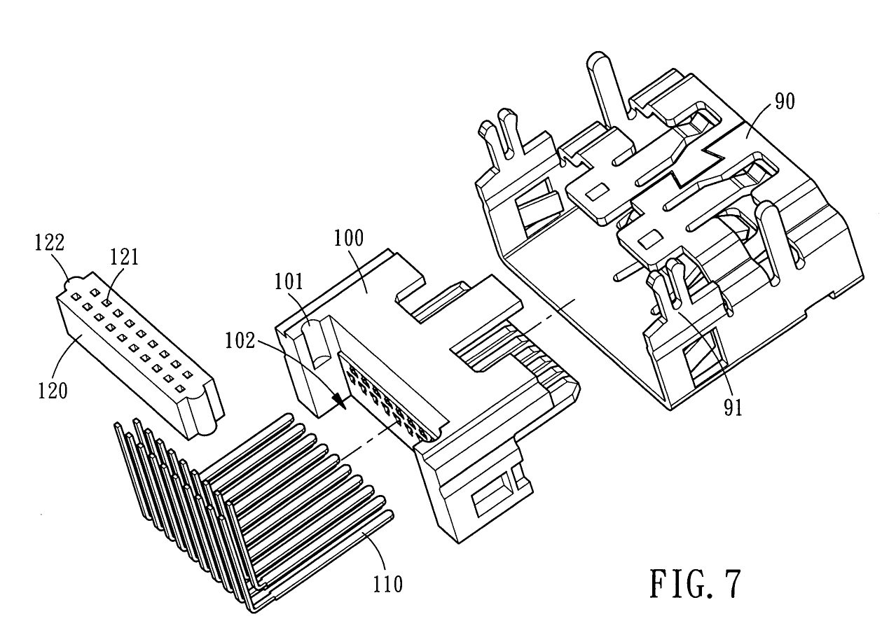

Referring to FIG. 7, a connector in accordance with a second embodiment of the present invention is shown, wherein the pins 91 are integral with the housing 90, the locking block 120 is formed with a plurality of inserting holes 121 for insertion of the terminals 110. The ribs 122 at both sides of the locking block 120 are inserted in the locking grooves 101 of the base 100, and the locking block 120 is positioned in the receiving groove 102 of the base 100.

It is to be noted that the locking block can also be engaged with the base in such a manner that the base has a pair of ribs inserted in a pair of receiving grooves formed in the locking block.

While we have shown and described various embodiments in accordance with the present invention, it should be clear to those skilled in the art that further embodiments may be made without departing from the scope of the present invention.

1. A connector having a plurality of terminals inserted in a receiving groove of a base thereof, wherein a locking block is positioned in the receiving groove of the base of the connector, and on the locking block are formed a plurality of inserting holes for insertion of terminals.

2. The connector as claimed in claim 1, wherein two locking grooves are formed at two opposite end of the receiving groove of the base, the locking block has ribs for engaging in the locking grooves of the base.

3. The connector as claimed in claim 1, wherein two ribs are formed at two opposite end of the receiving groove of the base, the locking block is formed with locking grooves for engaging in the ribs of the base.

4. The connector as claimed in claim 2, wherein each of the ribs of the locking block has a semicircular cross section.

5. The connector as claimed in claim 3, wherein each of the ribs of the base has a semicircular cross section.
